(19) United States
(12) Patent Application Publication
(10) Pub. No.: US 2003/0023479 A1
(43) Pub. Date: Jan. 30, 2003

(54) Information providing system capable of bi-directional targeting between information provider and client and control for displaying information, and information providing method

(76) Inventors: Jin-Hak Bae, Daejeon (KR); Si-Young Lee, Daejeon (KR); Hyeoung-Kyu Chang, Daejon (KR); Go-Bong Choi, Daejeon (KR); Byung-Geoul Choi, Daejeon (KR)

Correspondence Address: Michael A. Cantor, 55 Griffin South Road, Bloomfield, CT, 06002, US

(21) Appl. No.: 09/867,259

(22) Filed: May 29, 2001

(30) Foreign Application Priority Data
Sep. 26, 2000 (KR) 00-56410

(51) Int. Cl. G06F 17/60

(52) U.S. Cl. 705/14

(57) ABSTRACT

An information providing system capable of bi-directional targeting and control of information display, this system including a first storage unit for storing user-set data including at least one item among the sex of a user, the age of a user, and the concern area of a user, a second storage unit for storing a plurality of information and information attribution data in which at least one item among the sex of a target to which information is provided, the age of the target and the concern area of the target is defined for each information, a determiner for determining information to be provided to a user, according to whether the user set data is consistent with the information attribution data, and a provider for providing information determined by the determiner as information to be provided to a user, to the user. Accordingly, targeting of information and advertisement on the side of a provider and on the side of a user can be achieved using information attribution data and user set data that specify the requirements of an information provider and those of a user. Also, the information attribution data and the user set data are dynamically expressed with unit blocks, so that efficient targeting can be accomplished by the use of information attribution data and user set data that are variable depending on an application field. The format of displaying information and advertisement can be programmed using the window record and the information and advertisement control record within a control file, thereby enhancing the transmission efficiency of information and the advertisement effect.

### BACKGROUND OF THE INVENTION

1. Field of the Invention

The present invention relates to an information providing system and method of providing various information including advertisement on the Internet.

2. Description of the Related Art

As the Internet develops, and the number of Internet users increases, Internet sites providing information on the Internet are rapidly increasing. Besides, advertisement on the Internet is emerging as an important advertising means.

Models of a method of transmitting information on the Internet are usually a push model for a server transmitting information selected by the server itself to clients and a pull model for a client requesting necessary information to a server and receiving it from the server. In a push model, a server provides information selected by the server itself to clients registered via log-in. That is, providing or non-providing of information is determined by the server.

In a pull model, clients determine necessary information, request the determined information from a server, and receive the information from the server. That is, the server provides only requested information, so that provision or non-provision of information is totally determined by clients.

An existing push model can transmit produced information immediately to currently-registered clients, but has a drawback in that load on a server increases since the server must determine provision or non-provision of information to all registered clients. Also, the push model causes excessive network traffic due to increases in the number of registered clients and the amount of information to be transmitted. Furthermore, the server must always have accurate information on registered clients.

In an existing pull model, reception or non-reception of information is determined by clients, so that a server does not need to always possess accurate information on the clients and thus the burden on the server is reduced. However, it is difficult for clients to gain an accurate understanding of information newly added in a current server, so that the clients have difficulty in determining when, which and how much information produced in a server is to be requested.

Internet information providing systems according to the existing push model or pull model cannot provide a method of displaying provided information or advertisement and a programming method for controlling displaying of information such as the time zone, the number of times or the like. Therefore, the provided information or advertisement cannot help being displayed to users due to simple repetition.

### SUMMARY OF THE INVENTION

To solve the above problem, an objective of the present invention is to provide an information providing system and method capable of bi-directional targeting between an information provider and a client and control of displaying of information.

Another objective of the present invention is to provide a computer-readable recording medium which records an information providing method capable of bi-directional targeting between an information provider and a client and control of displaying of information.

The first objective of the present invention is achieved by an information providing system capable of bi-directional targeting between an information provider and a client and control of displaying of information, this system including: a first storage unit for storing user-set data including at least one item among the sex of a user, the age of a user, and the concern area of a user; a second storage unit for storing a plurality of information and information attribution data in which at least one item among the sex of a target to which information is provided, the age of the target and the concern area of the target is defined for each information; a determiner for determining information to be provided to a user, according to whether the user set data is consistent with the information attribution data; and a provider for providing information determined by the determiner as information to be provided to a user, to the user.

The first objective of the present invention is also achieved by an information providing method capable of bi-directional targeting between an information provider and a client and control of displaying of information, this method including: (a) receiving user-set data including at least one item among the sex of a user, the age of a user, and the concern area of a user, from a user; (b) extracting information corresponding to information attribution data in which at least one item among the sex of a target to which information is provided, the age of the target and the concern area of the target is defined, in accordance with each of the items of the user set data, and determining the extracted information to be provided to a user; and (c) providing the determined information to the user.

### BRIEF DESCRIPTION OF THE DRAWINGS

The above objectives and advantages of the present invention will become more apparent by describing in detail a preferred embodiment thereof with reference to the attached drawings in which:

FIG. 1 is a schematic configuration view of an information providing system capable of bi-directional targeting between an information provider and a client and control of displaying of information, according to the present invention;

FIG. 2 is a block diagram illustrating the internal structure of an information providing system capable of bi-directional targeting between an information provider and a client and control of displaying of information, according to an embodiment of the present invention;

FIG. 3 is a block diagram of the connection manager among the internal component members of the server shown in FIG. 2;

FIG. 4A is a schematic view illustrating the record structure of the control file shown in FIG. 3;

FIG. 4B is a schematic view illustrating the record structure of the information and advertisement file in memory shown in FIG. 3;

FIG. 5 shows a screen configuration for producing a control file in the operation system of FIG. 2;

FIG. 6 shows the relationship between the information attribution data 153b and the information and advertisement control record of the control file shown in FIG. 4A;

FIG. 6B is a flowchart illustrating an arithmetic algorithm of information attribution data and user-set data for determining reception or non-reception of information in the client terminal unit of FIG. 2; and

FIG. 7 is a flowchart illustrating an information providing method capable of an information providing system capable of bi-directional trageting between an information provider and a client and control of displaying of information, according to an embodiment of the present invention.

### DESCRIPTION OF THE PREFERRED EMBODIMENTS

The present invention will now be described more fully with reference to the accompanying drawings, in which a preferred embodiment of the invention is shown. In this specification, like reference numerals refer to like elements throughout.

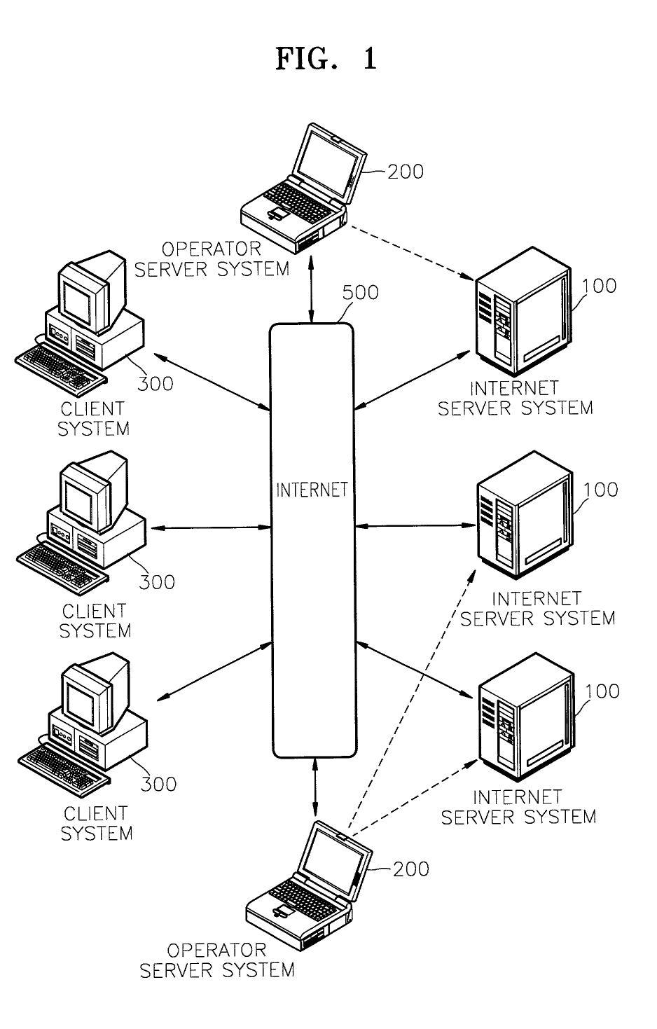

FIG. 1 is a schematic configuration view of an information providing system capable of bi-directional targeting between an information provider and a client and control of displaying of information, according to the present invention. Referring to FIG. 1, the information providing system according to the present invention includes at least one server 100, at least one operator server system 200 and at least one client terminal unit 300 which are connected to each other via the Internet 500. The server 100 provides information to the client terminal unit 300. The operator server system 200 manages and controls the server 100.

The client terminal unit 300 can be connected to the servers 100 via the Internet 500. The operator of the server 100 can manage and control the servers 100 via the Internet 500 in a remote control manner using the operator server system 200. In FIG. 1, the relationship between the operator server system 200 and the server 300 for managing the operator server system 200 is indicated in a dotted line. One operator server system 200 can manage at least one server 100.

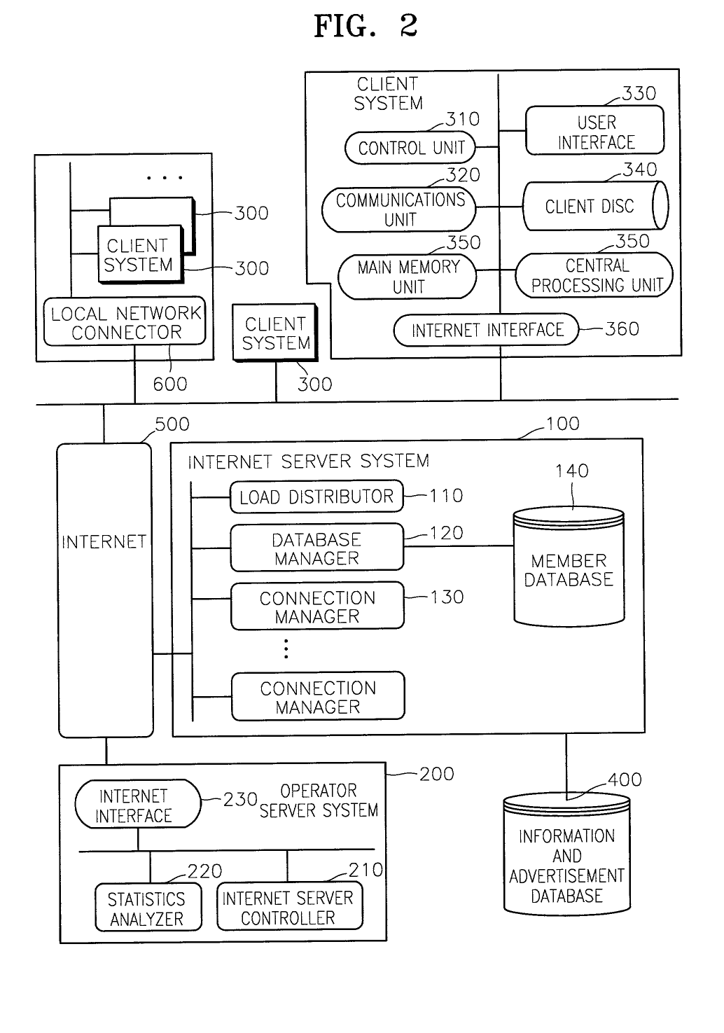

FIG. 2 is a block diagram illustrating the internal structure of an information providing system capable of bi-directional targeting between an information provider and a client and control displaying of information, according to an embodiment of the present invention. First, the server 100 includes a load distributor 110, a database manager 120, at least one connection manager 130 and a member database 140.

The load distributor 110 distributes information of connection managers 130 for performing operations to meet the connection request of the client terminal unit 300. Also, the load distributor 110 keeps information on the connection managers 130 and transmits the information of the connection managers 130 capable of processing the connection request of the client terminal unit 300 to the client terminal unit 300.

The connection managers 130 are connected to the client terminal unit 300 and performs an operation demanded by the client terminal unit 300. That is, the connection managers 130 transmit user-set data upon log-in of a user and also transmit corresponding information at a control file version request, a common time request, a control file download request and an information download request.

The user-set data is set to specify information that a user want to get. This will be described in detail later together with information attribution data set by an information provider, so will be described briefly. Users can selectively receive information suitable to user-set data, by determining the items of the user-set data made up of unit blocks such as the sex, the age, the concern area and the like.

Preferably, the user-set data is set when a user is connected to the server 100 for providing information and registers as a member. Also, it is preferable that, when a user logs in the server 100, the user-set data stored in the server 100 is transmitted to a corresponding client terminal unit 300.

To be described in brief, a control file is used to enable bi-directional targeting between an information provider and a user and control of information displaying. The control file is stored in the server 100, and transmitted to the client terminal unit 300 at the request of the client terminal unit 300. The client terminal unit 300 determines which information to receive and the time, the method, etc. to display the received information.

A control file version, which informs update or non-update of a control file, can be represented by an update date of the control file, and can also be expressed as a version composed of a combination of a number, a character and a symbol, for example, v1.0, whenever the control file is updated.

An internal common time, which is used by all of the client terminal units 300, is provided by the server 100.

Referring back to the internal configuration of the server 100, the database manager 120 analyzes the log-in information of a user and extracts the user-set data of a proper user from the member database 140. That is, the database manager 120 extracts user-set data corresponding to the user who has logged in from the member database 140 on the basis of the user log-in information. The database manager 120 also provides a common time at the common time request of the client terminal unit 300 through the connection managers 130.

The member database 140 stores information on members.

The client terminal unit 300 includes a control unit 310, a communications unit 320 and a client disc 340. Personal computers (PCs) capable of being connected to the Internet can be representative of the client terminal unit.

The communications unit 320 performs user log-in via the Internet and receives information from the server 100. That is, the communications unit 320 receives user-set data by performing user log-in using the connection managers 130 allocated by the load distributor 110 of the server 100, and also receives a control file version, a common time, an information file and the like.

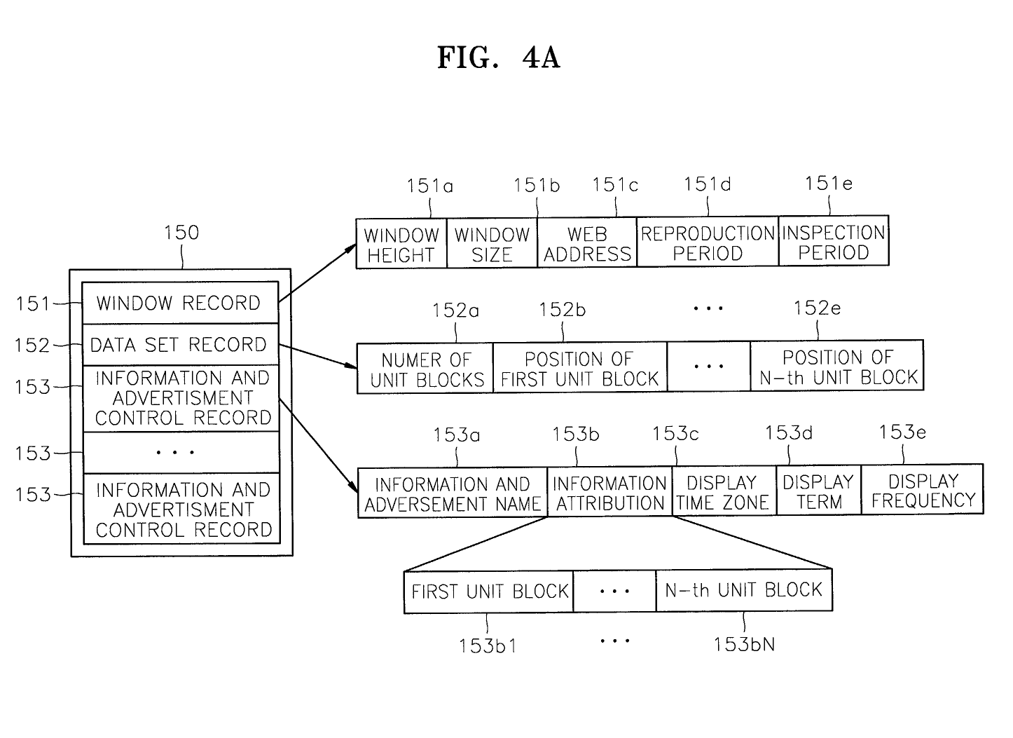

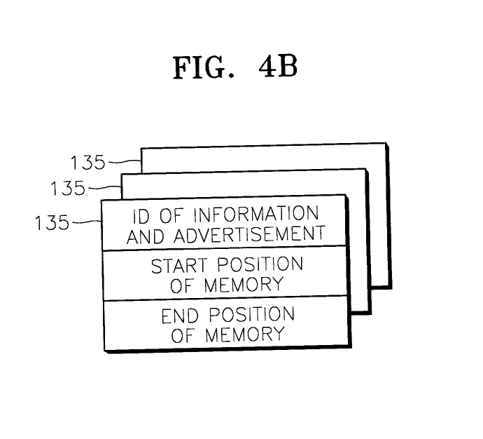

The control unit 310 determines information to receive by analyzing the control file and user-set data received by the communications unit 320, and receives corresponding information via the connection managers 130. The control unit 310 displays the received information to a user according to a displaying method described in the window record within the control file, on the basis of a displaying control program represented in an information and advertisement control record within the control file. The record structure of the control file will be described later with reference to FIGS. 4A and 4B.

The client disc 340 in the client terminal unit 300 stores the received control file and the received data.

The operator server system 200 includes a server controller 210 and a statistics analyzer 220. The server controller 210 produces a control file including control data on each information and a control file version on whether or not the control file has been updated. The server controller 210 also transmits the control file and the control file version together with information to more than one connection manager 130 of the server 100, and controls the connection managers 130.

The statistics analyzer 220 receives statistics information such as the download frequency of each data from the connection managers 130, and analyzes the received information.

The information providing system according to an embodiment of the present invention can separately include an information and advertisement database device 400 to store information and advertisement to be provided to users.

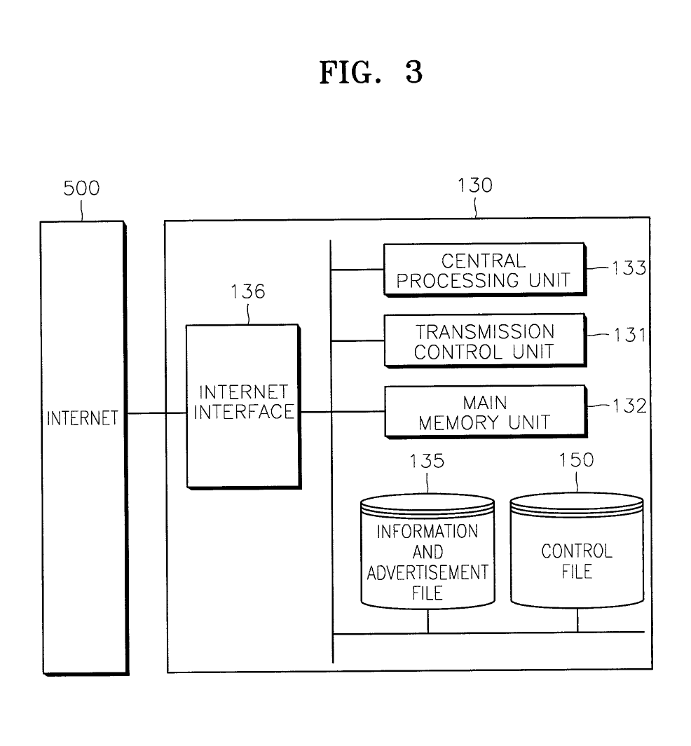

FIG. 3 is a block diagram of the connection manager among the internal component members of the server shown in FIG. 2. Referring to FIG. 3, the connection manager 130 of the server 100 includes a transmission control unit 131, a main memory unit 132, a central processing unit 133, a control file 150 and an information and advertisement file 135.

The transmission control unit 131 receives information and the control file 150 including control data on each information from the operator server system 200 and stores them in a disc in the form of the control file 150 and the information and advertisement file 135. After the transmission control unit 131 loads the control file and the data on the main memory unit 132, and then transmits the them at the request of the client terminal unit 300. The transmission control unit 131 also transmits a common time request to the database manager 120 at the request of the client terminal unit 300, and transmits control film version information on request.

FIG. 4A is a schematic view illustrating the record structure of the control file 150 shown in FIG. 3. Referring to FIG. 4A, the record structure of the control file 150 is made up of a window record 151 for controlling the format of displaying information in the client terminal unit 300, a data set record 152 for indicating the number of unit blocks of information attribution data, the positions of the unit blocks and the sizes thereof, and an information and advertisement control record 153 for each data.

The window record 151 includes a display window height 151a, a display window size 151b, a web address 151c of a web to be connected, a reproduction period 151d of the web address 151c and an inspection period 151e. The window height 151a indicates the vertical axis (y-axis) height of the screen of the client terminal unit 300 on which information is to be displayed. The window size 151b indicates the horizontal axis (x-axis) length of a portion on the client terminal unit 300 on which information and advertisement provided by the server 100 are displayed. Accordingly, the window height 151a and the window size 151b indicate the format of displaying information. The web address 151c and the reproduction period 151d indicate the web address of the server 100 to which the client terminal unit 300 is to be connected and the reproduction period of the web address, respectively. The inspection period 151e indicates a period in which the client terminal unit 300 demands a control file version of the server 100.

The data set record 152 is made up of a block 152a representing the number of unit blocks constituting information attribution data and blocks 152b through 152e representing the sizes and positions of the unit blocks. The data set record 152 can dynamically set up the configuration of the information attribution data, and thus provides the basis of performing efficient targeting between an information provider and a user according to the application field of the present invention by varying the information attribution data.

The information and advertisement control record 153 is made up of an information name 153a, information attribution data 153b set by a provider who provides information, a display time zone 153c when information is to be displayed to users, a display time 153d while information is displayed one time, and an information display frequency 153e. Here, the display time zone 153c, the display time 153d and the display frequency 153e can be considered to be a display control record for controlling the degree of displaying information.

To be more specific, the information attribution data 153b is made up of unit blocks 153b1 through 153bN. The unit blocks 153b1 through 153bN of the information attribution data 153b indicate, for example, the sex of a user, the age thereof and the concern field thereof, and the like. Thus, reception or non-reception of information can be determined through the logic operation of corresponding information attribution data set by a provider and user-set data set by a user. Preferably, the information attribution data 153b can dynamically express various requirements by controlling the number of unit blocks and the sizes thereof using the data set record 152 within the control file 150.

The information attribution data 153b of the information and advertisement control record 153 sets up the properties of users to be provided with information by an information provider. Thus, the information provider can provide information not to an arbitrary user but to the users in a particular group.

Similarly, users who want to receive information can download only their desired information from the server 100 by setting user set data. Accordingly, bi-directional targeting between an information provider and a user can be accomplished.

An information provider can program the degree to which corresponding advertisement and information are displayed on the client terminal unit 300, by setting up the display time zone 153c, the display time 153d and the display frequency 153e of the information and advertisement control record 153.

The record structure of the control file 150 of FIG. 4A is just an example, so, undoubtedly, addition or change to the elements of the control file 150 can be achieved.

FIG. 4B is a schematic view illustrating the record structure of the information and advertisement file in memory 135 shown in FIG. 3. Referring to FIG. 4B, the record structure of the information and advertisement file 135 is made up of the identifications (ID) of information and advertisement, the start position of a memory and the end position thereof.

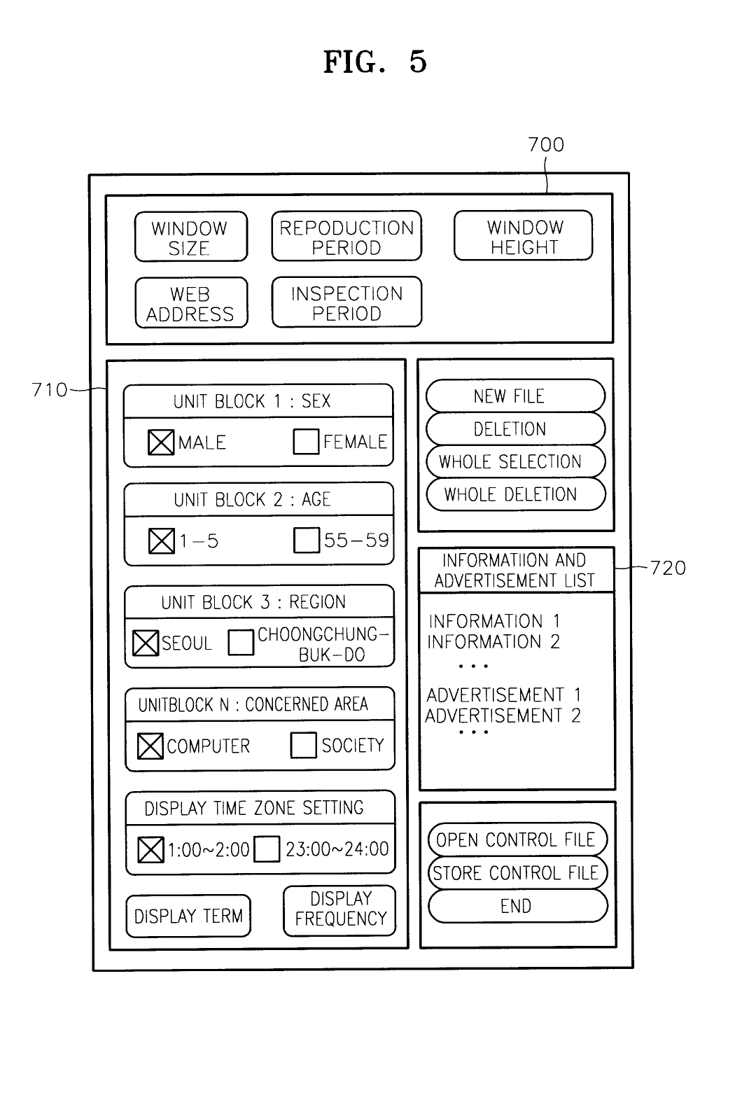

FIG. 5 shows the configuration of a screen for producing the control file 150 in the operation system 200 of FIG. 2. In FIG. 5, the uppermost area 700 of the screen sets up the window record 151, the left area 710 sets up the information and advertisement control record 153, and the right middle area 720 represents the list of information and advertisement included in the control file 150.

An information provider can set up the records of the control file 150 on a control file production screen using the operator server system 200. As shown in FIG. 5, an information provider can set up the information attribution data 153b by specifying the properties of a user to receive information into the sex, the age, the concern area and the like. Also, the information provider can program the degree to which information is displayed, such as the information display time zone, the information display frequency and the like.

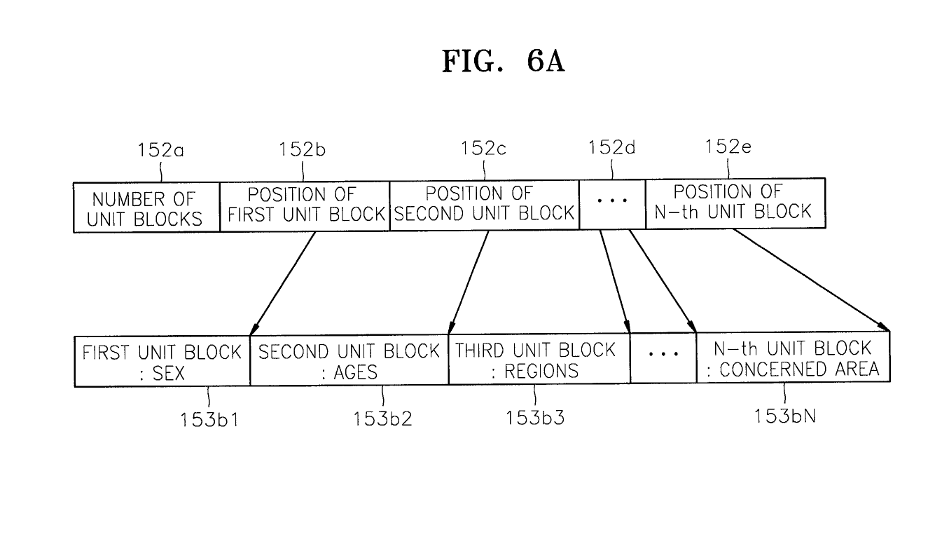

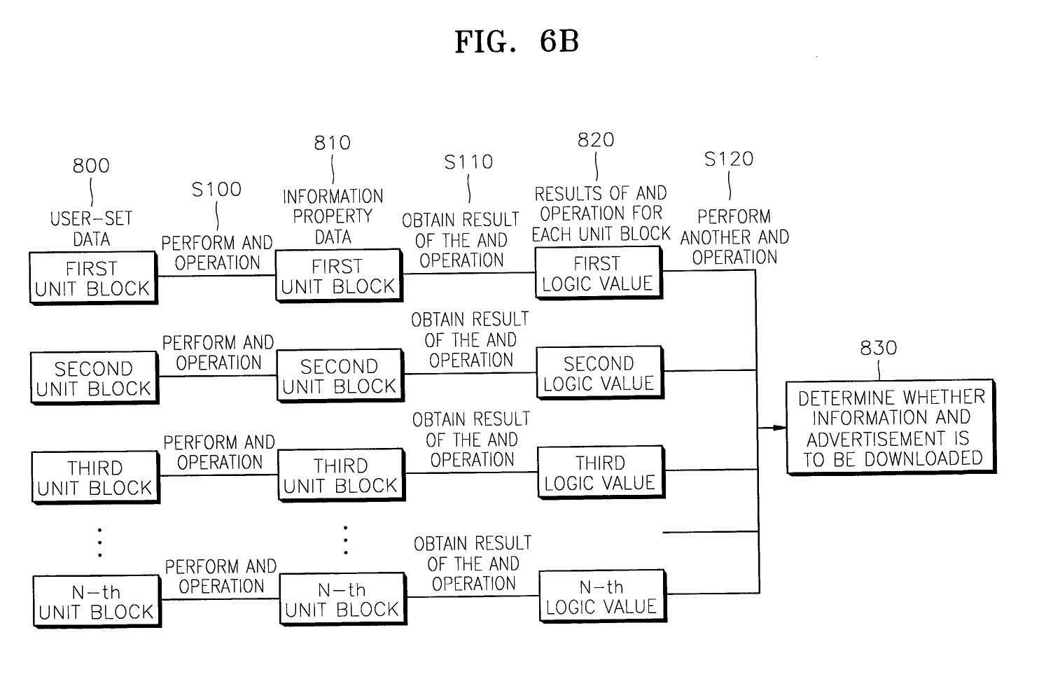

FIG. 6A shows the relationship between the information set record 152 and the information attribution data 153b in the control file 150 shown in FIG. 4A. Referring to FIG. 6A, the information set record 152 is made up of the block 152a representing the number of unit blocks, and the first through N-th unit block positions 152b through 152e. The information attribution data 153b is made up of first through N-th unit blocks 153b1 through 153bN.

In FIG. 6A, the first unit block 153b1 represents the sex of a user, the second unit block 153b2 represents the age of a user, the third unit block 153b3 represents the region of a user, and the N-th unit block 153bN represents the concern area of a user. The unit block positions 152b through 152e indicate the ends of the unit blocks 153b1 through 153bN, respectively. Since there is no need to equalize the intervals between the unit block positions 152b through 152e, the size of each of the unit blocks can differ from each other by indicating the unit block positions 152b through 152e.

FIG. 6B is a flowchart illustrating an arithmetic algorithm between information attribution data and user-set data for determining reception or non-reception of information in the client terminal unit 300 of FIG. 2. In FIG. 6B, the client terminal unit 300 performs an AND operation for each unit bock on user set data 800 received through log-in and information attribution data 810 included in the information and advertisement control record 153 of a control file, in order to determine download or non-download of specific information, in step S100. The results of the AND operations are obtained, in step S110. Logic operation results 820 for unit blocks again undergo AND operations, in step S120. In step S120, a determination as to whether information and advertisement is to be downloaded is made using the results 830 of the second AND operations.

In the determination as to whether specific information is to be downloaded, it is ascertained whether data input by a user about each item of the user set data 800 is consistent with data on the corresponding item of the information attribution data 810, and, accordingly, information and advertisement corresponding to information attribution data in which all items are consistent with the user-input data can be determined as information and advertisement to be downloaded.

If data input by a user about a specific item of the user set data 800 is consistent with data on the corresponding item of the information attribution data 810, information and advertisement corresponding to the information attribution data can be determined to be downloaded. On the other hand, if data input by a user about a specific item of the user set data 800 is inconsistent with data on the corresponding item of the information attribution data 810, information and advertisement corresponding to the information attribution data can be excluded from information and advertisement to be downloaded.

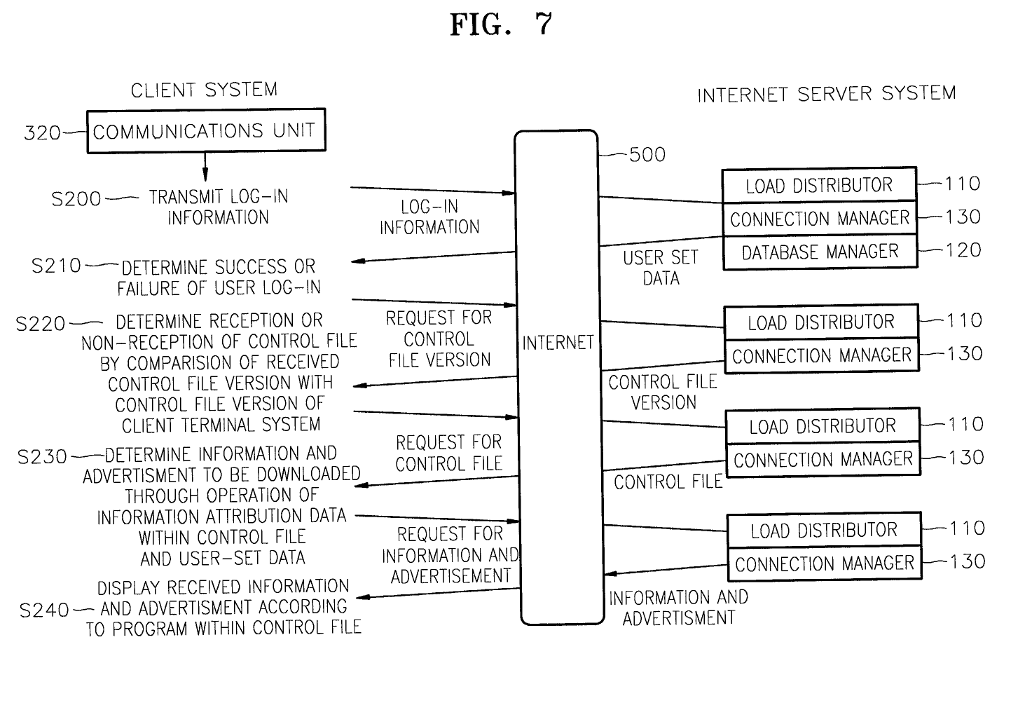

FIG. 7 is a flowchart illustrating an information providing method capable of an information providing system capable of bi-directional targeting between an information provider and a user and control of displaying of information, according to an embodiment of the present invention. The information and advertisement providing method according to the present invention shown in FIG. 7 is performed in an information and advertisement providing system according to the present invention. Hereinafter, the process in which the client terminal unit 300 is provided with information and advertisement using user set data and information attribution data will be described on the whole with reference to FIG. 7.

First, the communications unit 320 of the client terminal unit 300 transmits user log-in information to the server 100, in step S200. User set data extracted by the database manager 120 of the server 100 is transmitted to the client terminal unit 300 via the connection manager 120, and the client terminal unit 300 determines a success or a failure of log-in by receiving the user set data, in step S210.

When proper user set data is received by the success of log-in, the client terminal unit 300 demands a control file version of the server 100 and receives it from the server 100. Next, reception or non-reception of a control file is determined by comparing the received control file version with the control file version of the client terminal unit 300, in step S220.

If the version of a control file has been upgraded, the control file is received from the server 100, and existence or non-existence of information and advertisement to be downloaded is determined through the operation of the information attribution data on each information and advertisement in the control file and the user set data received in step S210, in step S230.

If there are information and advertisement to be downloaded, the client terminal unit 300 requests the server 100 to provide information and advertisement and receives the requested information and advertisement from the server 100. Then, the received information and advertisement is displayed to a user according to the window record and the display control record, that is, the display time zone, the display time and the display frequency, of the information and advertisement control record within the control file, in step S240.

As described above, an information providing system capable of bi-directional targeting between an information provider and a user and control of displaying of information is generally made up of a client terminal unit, a server and an operating system connected to a communications network. However, the information providing system can be a system into which the functions of the above systems are integrated, enabling the bi-directional targeting between an information provider and a user and control of displaying information.

In this embodiment, the client terminal unit determines information to be transmitted from the Internet server system to the client terminal unit. However, the information providing system can be designed so that the server determines information to be transmitted to the client terminal unit.

In this case, when a user is connected to the server, user-set data stored in the client terminal unit is transmitted to the server, and the server determines information to be transmitted to the client terminal unit by ascertaining whether information attribution data is consistent with the data of each item of the received user-set data.

The term “information and advertisement” used in this specification does not mean that advertisement must be always provided together with information, but means that all information desired to provide, including advertisement, can be provided using the present invention.

Although the invention has been described with reference to a particular embodiment, it will be apparent to one of ordinary skill in the art that modifications of the described embodiment may be made without departing from the spirit and scope of the invention.

According to the present invention, bi-directional targeting between an information and advertisement provider and a user and control of displaying of information can be achieved. That is, targeting of information and advertisement on the side of a provider and on the side of a user can be achieved using information attribution data and user-set data that specify the requirements of an information provider and those of a user. Also, the use of a control file version and a control file can reduce the load upon the network caused by a push model and solve the problems of a push model associated with the point of time when information and advertisement are transmitted and the amount of information and advertisement transmitted.

Furthermore, the information attribution data and the user-set data are dynamically expressed with unit blocks, so that efficient targeting can be accomplished by the use of information attribution data and user set data that are variable depending on an application field. The format of displaying information and advertisement can be programmed using the window record and the information and advertisement control record within a control file, thereby enhancing the transmission efficiency of information and the advertisement effect.

What is claimed is:

1. An information providing system comprising:
a first storage unit for storing user-set data including at least one item among the sex of a user, the age of a user, and the concern area of a user;
a second storage unit for storing a plurality of information and information attribution data in which at least one item among the sex of a target to which information is provided, the age of the target and the concern area of the target is defined for each information;
a determiner for determining information to be provided to a user, according to whether the user set data is consistent with the information attribution data; and
a provider for providing information determined by the determiner as information to be provided to a user, to the user.

2. The information providing system of claim 1, wherein the determiner determines information corresponding to the information attribution data as information to be provided to a user, according to whether the data of each item of the user set data is consistent with the data of each item of the information attribution data.

3. The information providing system of claim 1, wherein if the data of a specific item of the user set data is consistent with the data of a corresponding specific item of the information attribution data, the determiner determines information corresponding to the information attribution data as information to be provided to a user.

4. The information providing system of claim 1, wherein the provider comprises connection managers for providing user set data corresponding to a connected user, the information attribution data and the information determined by the determiner, to the user.

5. The information providing system of claim 1, wherein the number of items of the information attribution data, the number of items of the user set data, and the sizes of the items are variably set.

6. The information providing system of claim 1, wherein the determiner requests the provider to provide information on whether information attribution data and data set information has been updated, at determination intervals defined in determination information configuring the determination interval for determining whether the information attribution data and the data set information indicating the number of unit blocks of the information attribution data and the positions and sizes of the unit blocks have been updated, and requests the provider to provide the information attribution data and the data set information if the information attribution data and the data set information have been updated to the information attribution data and the data set information stored in the determiner.

7. The information providing system of claim 1, further comprising an operating unit which manages at least one provider, produces information attribution data and data set information and provides the same to the provider.

8. The information providing system of claim 1, further comprising a third storage unit having an information display format including the size of an information display window, a regeneration period and an information display method and an information display degree including an information display time zone, the length of one information displaying duration, and the frequency of displaying information, wherein the determiner displays information received from the provider according to the information display format and the information display degree.

9. An information providing system comprising:
a database unit for storing user-set data including at least one item among the sex of a user, the age of a user, and the concern area of a user, a plurality of information, and information attribution data in which at least one item among the sex of a target to which information is provided, the age of the target and the concern area of the target is defined for each information;
a user terminal unit for determining information to be demanded of a server, according to whether the user set data is consistent with the information attribution data, and displaying information provided by the server; and
a server for transmitting requested information to the user terminal unit.

10. The information providing system of claim 9, wherein the user terminal unit comprises an information determiner for determining information corresponding to the information attribution data as information to be provided to a user, according to whether the data of each item of the user set data is consistent with the data of each item of the information attribution data, or requesting the server to provide information corresponding to the information attribution data if the data of a specific item of the user set data is consistent with the data of a corresponding specific item of the information attribution data.

11. The information providing system of claim 9, wherein the server comprises at least one connection manager for transmitting user set data corresponding to a connected user and the information attribution data to the user terminal unit and transmitting the information requested by the user terminal unit to the user terminal unit.

12. The information providing system of claim 9, wherein the number of items of the information attribution data, the number of items of the user set data, and the sizes of the items are variably set.

13. The information providing system of claim 9, wherein the user terminal unit requests the server to provide information on whether information attribution data and data set information has been updated, at determination intervals defined in determination information configuring the determination interval for determining whether the information attribution data and the data set information indicating the number of unit blocks of the information attribution data and the positions and sizes of the unit blocks have been updated, and requests the server to provide the information attribution data and the data set information if the information attribution data and data set information have been updated to the information attribution data and the data set information stored in the determiner.

14. The information providing system of claim 9, further comprising an operating server which manages at least one server and produces the information attribution data and the data set information and provides the same to the server.

15. An information providing system comprising:
a database unit for storing user-set data including at least one item among the sex of a user, the age of a user, and the concern area of a user, a plurality of information, and information attribution data for each information in which at least one item among the sex of a target to which information is provided, the age of the target and the concern area of the target is defined;
a user terminal unit for transmitting user set information received from a user to a server and displaying information received from the server; and
a server for determining information to be transmitted to the user terminal unit, according to whether the user set data received from the user terminal unit is consistent with the information attribution data and transmitting the determined information to the user terminal unit.

16. The information providing system of claim 15, wherein the server comprises an information determiner for determining information corresponding to the information attribution data to be provided to a user, according to whether the data of each item of the user set data is consistent with the data of each item of the information attribution data, or determining information corresponding to the information attribution data to be transmitted to the user terminal unit, if the data of a specific item of the user set data is consistent with the data of a corresponding specific item of the information attribution data.

17. The information providing system of claim 15, wherein the server comprises at least one connection manager for transmitting user set data and information attribution data corresponding to a connected user to the user terminal unit and transmitting information determined by the information determiner to the user terminal unit.

18. The information providing system of claim 15, wherein the number of items of the information attribution data, the number of items of the user set data, and the sizes of the items are variably set.

19. The information providing system of claim 15, further comprising an operating server which manages at least one server and produces the information attribution data and the data set information and provides the same to the server.

20. The information providing system of claim 9 or 15, wherein the database unit further includes an information display format including the size of an information display window, a regeneration period and an information display method and an information display degree including an information display time zone, the length of one information displaying duration, and the frequency of displaying information, and the user terminal unit displays received information according to the information display format and the information display degree.

21. An information providing method comprising:
(a) receiving user-set data including at least one item among the sex of a user, the age of a user, and the concern area of a user, from a user;
(b) extracting information corresponding to information attribution data in which at least one item among the sex of a target to which information is provided, the age of the target and the concern area of the target is defined, in accordance with each of the items of the user set data, and determining the extracted information to be provided to a user; and
(c) providing the determined information to the user.

22. The information providing method of claim 21, wherein, in the step (b), the determined information is information corresponding to the information attribution data according to whether the data of each item of the user set data is consistent with the data of each item of the information attribution data, or information corresponding to the information attribution data according to whether the data of a specific item of the user set data is consistent with the data of a corresponding specific item of the information attribution data.

23. The information providing method of claim 21, wherein the number of items of the information attribution data, the number of items of the user set data, and the sizes of the items are variably set.

24. The information providing method of claim 21, wherein in the step (c), information to be provided to a user includes an information display format including the size of an information display window, a regeneration period and an information display method and an information display degree including an information display time zone, the length of one information displaying duration, and the frequency of displaying information.

25. A recording medium capable of being read by a computer in which a computer program is recorded, the computer program comprising:
(a) receiving user-set data including the sex of a user, the age of the user, and the concern area of the user from a user;
(b) extracting information corresponding to information attribution data in which at least one item among the sex of a target to which information is provided, the age of the target and the concern area of the target is defined, in accordance with each of the items of the user set data, and determining the extracted information to be provided to a user;
(c) providing the determined information, an information display format including the size of an information display window, a regeneration period and an information display method, and an information display degree including an information display time zone, the length of one information displaying duration, and the frequency of displaying information, to the user.
